(19) United States
(12) Patent Application Publication
(10) Pub. No.: US 2006/0186643 A1
(43) Pub. Date: Aug. 24, 2006

(54) Method and apparatus for a portable shelter with an axle having a unitary member

(76) Inventor: Mark LaBore, Ham Lake, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/061,758

(22) Filed: Feb. 18, 2005

(51) Int. Cl. B62B 1/00; B62B 5/00

(52) U.S. Cl. 280/656; 280/38

(57) ABSTRACT

A trailer, comprising: an ice fishing shelter including a base with a recess; a first pivot arm and a second pivot arm interconnected by a unitary member, the first pivot arm connected to the ice fishing shelter at a first joint and the second pivot arm connected to the ice fishing shelter at a second joint; a first wheel assembly connected to the first pivot arm; and a second wheel assembly connected to the second pivot arm; wherein the adjustable actuator is adapted to position the first pivot arm and the second pivot arm with respect to the ice fishing shelter to elevate the ice fishing shelter and base for towing on the first wheel assembly and the second wheel assembly and to lower the ice fishing shelter and base to a planar surface with the recess accommodating the unitary member.

### TECHNICAL FIELD

This disclosure relates generally to portable shelters, and more particularly to a method and apparatus for a portable shelter with an axle having a unitary member.

### BACKGROUND

There are a number of portable shelters for different uses. One such portable shelter is an ice fishing shelter. An ice fishing shelter is typically transported by a trailer which may be separate or integral with the ice fishing shelter. Such trailers are typically adapted for trailering behind a vehicle.

One problem with existing trailer designs involves integrating the trailer with the portable shelter. The resulting designs lack structural integrity and can result in unstable configurations under tow. Thus, there is a need in the art for designs which can rest a shelter on the ground while providing a robust trailer design which can sustain the stresses of transportation when the shelter is elevated.

### SUMMARY

The above-mentioned problems and others not expressly discussed herein are addressed by the present subject matter and will be understood by reading and studying this specification.

An embodiment of the present subject matter includes a trailer, comprising: an ice fishing shelter including a base; a first pivot arm and a second pivot arm interconnected by a unitary member, the first pivot arm connected to the ice fishing shelter at a first joint and the second pivot arm connected to the ice fishing shelter at a second joint; a first wheel assembly connected to the first pivot arm; and a second wheel assembly connected to the second pivot arm; wherein the adjustable actuator is adapted to position the first pivot arm and the second pivot arm with respect to the ice fishing shelter to elevate the ice fishing shelter and base for towing on the first wheel assembly and the second wheel assembly and to lower the ice fishing shelter and base to a planar surface with the unitary member disposed between the base and the planar surface.

An additional embodiment of the present subject matter includes a trailer, comprising: an ice fishing shelter, including a base; a first pivot arm connected to the ice fishing shelter, the first pivot arm connected to a first wheel assembly means for rolling the trailer across a planar surface; a second pivot arm connected to the ice fishing shelter, the second pivot arm connected to a second wheel assembly means for rolling the second pivot arm across the planar surface; a unitary member means for interconnecting the first wheel assembly means and the second wheel assembly means; and elevation means for adjusting the elevation of the ice fishing shelter and the base, wherein the elevation means are adapted to elevate the ice fishing shelter means and base for towing on the first wheel assembly means and the second wheel assembly means and to lower the ice fishing shelter means and base to the planar surface with the unitary member means disposed between the base and the planar surface.

An additional embodiment of the present subject matter includes a trailer, comprising: an ice fishing shelter including a base with a recess; a first pivot arm and a second pivot arm, the first pivot arm connected to the ice fishing shelter at a first joint and the second pivot arm connected to the ice fishing shelter at a second joint; a first wheel connected to a first hub, the first hub connected to a first leaf spring, the first leaf spring connected to the first pivot arm; a second wheel connected to a second hub, the second hub connected to a second leaf spring, the second leaf spring connected to the second pivot arm; a unitary member interconnecting the first hub and the second hub; a pivoting hitch tongue connected to the ice fishing shelter at a third joint; and a hand adjustable winch connected to the pivoting hitch tongue with cabling extending between the hand adjustable winch and the first and second pivot arm, the cabling constraining the movement of the first and second pivot arm with respect to the ice fishing shelter, wherein the hand adjustable winch is adapted to elevate the ice fishing shelter and base for towing on the first wheel and the second wheel and to lower the ice fishing shelter and base to a planar surface with the unitary member disposed through the recess between the base and the planar surface.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

FIG. 1A is a side view of a lowered trailer, according to one embodiment of the present subject matter.

FIG. 1B is a side view of a trailer elevated for towing, according to one embodiment of the present subject matter.

FIG. 2A is a perspective view of a trailer adjusted to an elevated position, according to one embodiment of the present subject matter.

FIG. 2B is a perspective view of a lowered trailer, according to one embodiment of the present subject matter.

FIG. 3 is a top view of an interconnected wheel assemblies and unitary member, according to one embodiment of the present subject matter.

FIG. 4 is a break-away side view of a recess, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

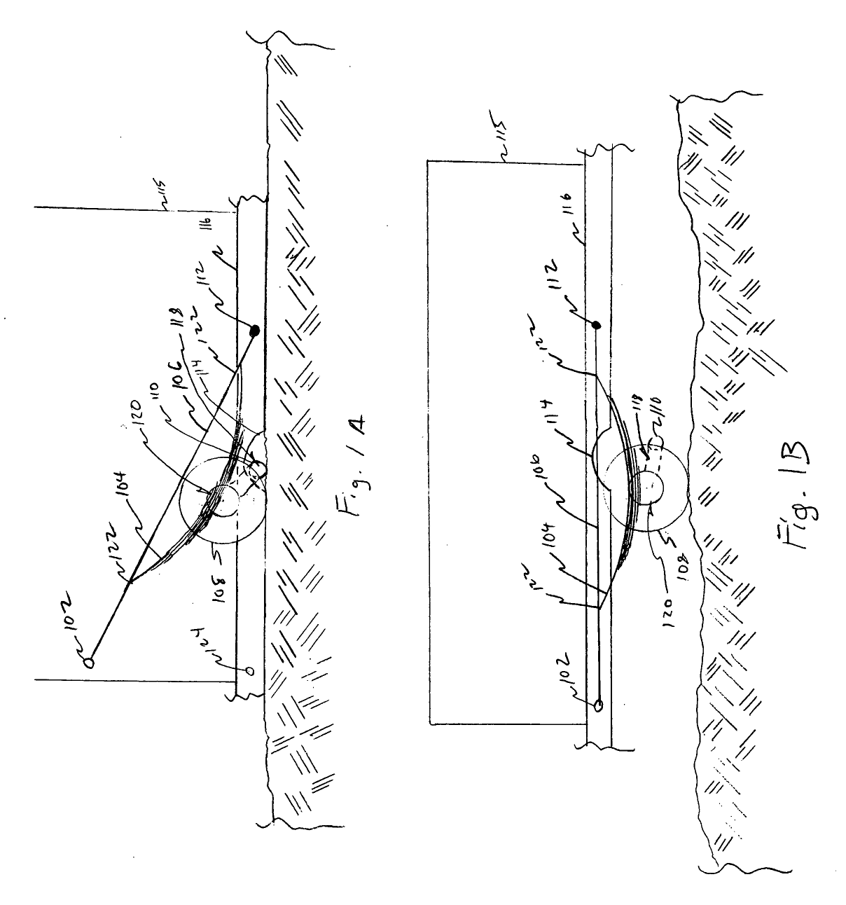

FIG. 1A is a side view of a lowered trailer, according to one embodiment of the present subject matter. Various embodiments of the trailer include an ice fishing shelter 115 with a base 116. In various embodiments, the base 116 is a structure connected to a fishing shelter 115. In various embodiments the base 116 represents the bottom portion of an integrated ice fishing shelter 115. The ice fishing shelter 115 may be any of the known varieties used, which typically include holes in their floor for ice fishing, but the present subject matter is not so limited.

Also included in the illustration is axle 118. Since the illustration is a side view, only one wheel assembly is pictured, but the axle 118 includes at least two wheel assemblies, in various examples. A wheel assembly 120 includes a tire 108 and/or other structures enabling the wheel assembly 120 to rotate with respect to the ice fishing shelter 115. Various combinations of these components and components not listed here are within the scope of the present subject matter. Various wheel assembly means such as these can include suspension components, such as springs and dampers, and other parts. In one embodiment, a wheel assembly means includes a tire, rim and hub, with the hub bolted to a leaf spring, but the present subject matter is not so limited.

The axle 118 includes a unitary member 110, in various embodiments. The unitary member 110 extends across ice fishing shelter 115 and base 116 and is connected to at least a first and a second wheel assembly, in various examples. Connection between the axle 118 and the ice fishing shelter 115 is provided by a pivot arm 106, in various embodiments. For example, in one embodiment, the unitary member 110 is connected to a wheel assembly 120, which is connected to a leaf spring 104, which is connected to a pivot arm 106 with shackles 122, which is connected to ice fishing shelter 115 at pivot 112. This embodiment provides one illustration of the present subject matter. Additional embodiments include other combinations of these parts and can include parts not listed here expressly. For example, a wheel assembly 120 can connect directly to a pivot arm 106 in one embodiment. Additionally, various dynamic suspension configurations besides leaf spring 104 are within the scope of the present subject matter, such as struts, torsion bars, or other known suspension designs.

The present subject matter provides various benefits over known embodiments. For example, the present subject matter, through connection of multiple wheel assemblies to a unitary member 110, is able to keep the wheel assemblies in better alignment than embodiments which do not interconnect the wheel assemblies. Other embodiments which, for example, connect a wheel assembly solely to a pivot arm 106, and do not interconnect one wheel assembly to another, do not have the benefit of the rigidity of unitary member 110 in maintaining alignment.

The present subject matter is adapted for adjustment from an elevated position for towing to a lowered position for resting a base portion 116 of the ice fishing shelter 115 on a surface, such as ice. FIG. 1A illustrates one embodiment of a lowered trailer, according to the present subject matter. FIG. 1B illustrates one embodiment of a trailer elevated for towing, according to one embodiment of the present subject matter. Various embodiments include an adjustable actuator which facilitates controlling the position of pivot arm 106 with respect to the ice shelter 115. One embodiment includes a winch which pulls the pivot arm toward the ice shelter 115 while adjusting the trailer for elevated towing, and which allows gravity to push the pivot arm away from the ice shelter for lowering the ice shelter to a surface, but other actuators are within the scope of the present subject matter.

In order to facilitate such adjustability, various embodiments include features, such as a recess 114. A recess is adapted to provide for the unitary member 110 to pass beneath the ice fishing shelter 115 while the ice fishing shelter 115 is lowered to the ground, with a base portion 116 touching the ground, in various embodiments. Although the recess is arc shaped in the present illustration, other shapes are within the scope of the present subject matter, such as box shapes or slot shapes.

Further enabling adjustment are a first eyelet 102 and a second eyelet 124, which are adapted to for passage of a pin, in various embodiments. In various embodiments, a pin is combined with first eyelet 102 and second eyelet 124, fixing pivot arm 106 with respect to ice fishing shelter 115. This design relieves the stress of towing which would otherwise be transmitted to the adjustable actuator. In one embodiment, a pin used to hold first eyelet 102 to second eyelet 124 is lockable, including a push-button designs, ball detent designs, and other designs.

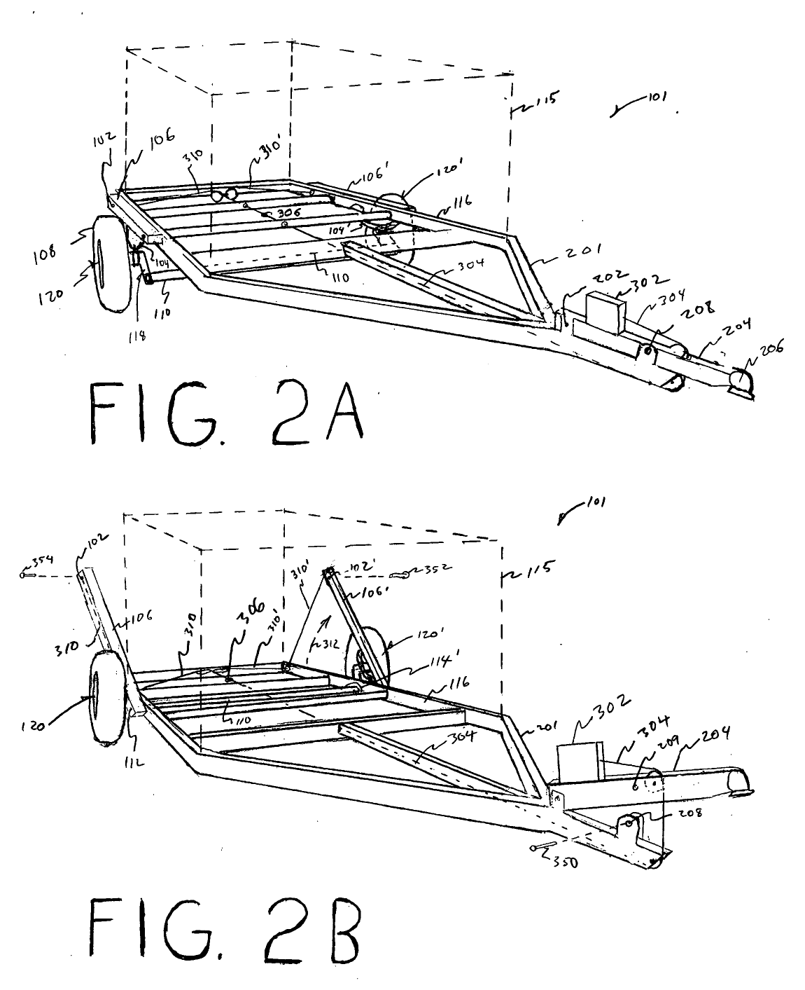

FIG. 2A is a perspective view of a trailer 101 adjusted to an elevated position, according to one embodiment of the present subject matter. The ice fishing shelter 115 includes a base 116. Additional components are pictured, such as a tongue 201. Also visible in the illustration are pivot arms 106, 106′, eyelet 102, wheel assemblies 120, 120′, leaf springs 104, 104′, and unitary member 110.

Pivoting hitch tongue 204 is connected to tongue 201 at a tongue pivot 202. The pivoting hitch tongue 204 is adapted to remain connected to a vehicle while the trailer 101 is lowered onto a surface. This saves time setting up the ice fishing shelter for ice fishing. The pivoting hitch tongue 204 and ice fishing shelter 115, in various embodiments, are lockable through one or more eyelets 208. In various embodiments, the pivoting hitch tongue 204 includes an interface for towing, such as a ball hitch 206. Although not pictured, additional towing interfaces are within the scope of the present subject matter, such as pintle hook designs, and other designs.

Additionally pictured in the illustration is an adjustable actuator 302. In various embodiments, the adjustable actuator is adapted to position the first pivot arm 106 and the second pivot arm 106′ with respect to the ice fishing shelter 115 to elevate the ice fishing shelter 115 and base 116 for towing on the first wheel assembly 120 and the second wheel assembly 120′ and to lower the ice fishing shelter 115 including its base 116 to a planar surface with the unitary member 110 disposed between the base 116 and the planar surface. In various embodiments, the adjustable actuator 302 is a hand adjustable winch. In some embodiments, the hand adjustable winch is connected to a primary cable 304, which is the connected to a first branch cable 310 and a second branch cable 310′. Within some of these embodiments, the primary cable 304 is connected to the first cable 310 and the second cable 310′ using a splice 306. In some embodiments, the use of the cabling requires the use of a plurality of pulleys threaded with the cabling. In these embodiments, the cabling extends from the hand adjustable winch to the first and second pivot arms, and across the plurality of pulleys.

FIG. 2B is a perspective view of a trailer 101 adjusted to position a base portion of a shelter onto a planar surface, according to one embodiment of the present subject matter. The connected adjustable actuator 302, cabling, and pivot arms 106, 106′ comprise just one means of adjustably controlling the elevation of the trailer. Additional elevation means can use various additional joints and actuators. Added design aspects within the scope of the present subject matter, for example, include worm-drive actuators. Elevation means can also include gear driven pivot arms. The illustration additionally shows how, in some embodiments, elevation means include recesses 114, 114′ through which the unitary member 110 passes when the trailer is lowered to the surface.

Various design features for fixing movable parts together can provide for robust towing, in various embodiments. In FIG. 2B, pivot arm 106, contralateral pivot arm 106′, and pivoting tongue hitch 204 are not fixed to ice fishing shelter 115 at respective eyelets 102, 102′, 208. Shown removed from the eyelets is first pin 354 for pinning eyelet 102 to ice fishing shelter 115. Additionally shown is second pin 352 for pinning eyelet 102′ to ice fishing shelter 115. Also shown is third pin 350 for pinning pivot hitch tongue 204 to ice fishing shelter 115. When adjustable parts are not pinned or otherwise locked in place, the adjustable actuator 302 controls the position of the trailer relative to the ground. To reduce stress on the adjustable actuator 302, pinning movable parts in a fixed state can provide for robust towing when the trailer is elevated.

Thus, various methods of adjusting a trailer are provided. One method embodiment includes adjusting an adjustable actuator which is adapted to position the first pivot arm and the second pivot arm with respect to the ice fishing shelter to elevate the ice fishing shelter and base for towing on the first wheel assembly and the second wheel assembly and to lower the ice fishing shelter and base to a planar surface with the unitary member disposed between the base and the planar surface. Some variations of the method include removing a plurality of locking pins which lock the first pivot arm 106, the second pivot arm 106′, and the pivot hitch tongue 204 to ice fishing shelter 115 for use in an elevated adjustment. Some method embodiments also include maintaining a connection between a pivot hitch tongue 204 and a vehicle while the trailer is lowered to a surface. In various embodiments, the method also includes towing the connected parts with a vehicle while the trailer is adjusted to an elevated position.

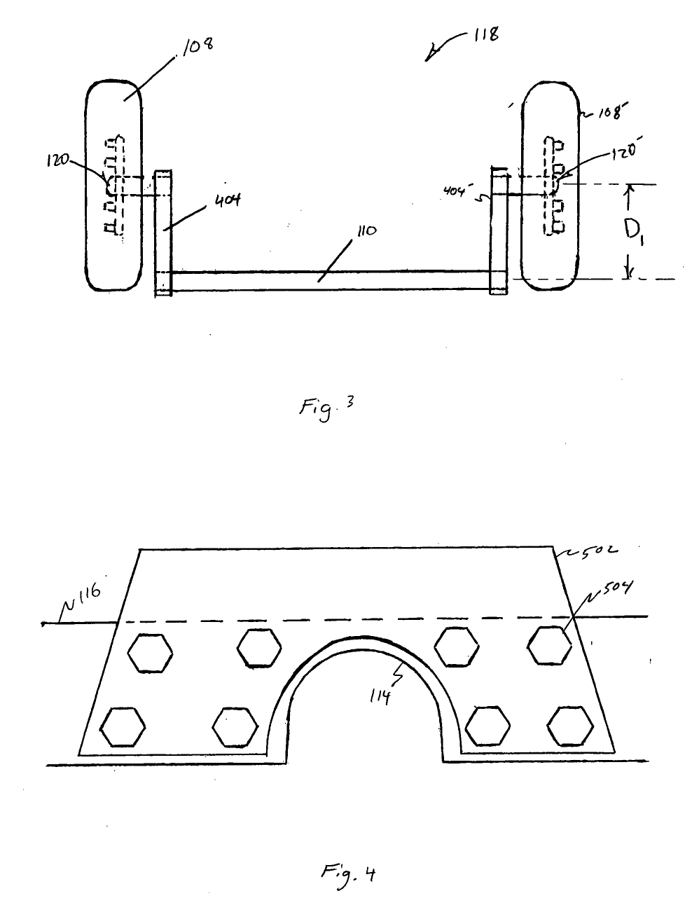

FIG. 3 is a top view of an axle 118, according to one embodiment of the present subject matter. The illustration shows axle 118, which includes an interconnected unitary member 110 and at least two wheel assemblies 120, 120′, in various embodiments. These interconnected means, in various embodiments, are not limited to the pictured example, and can include various configurations. For example, the pictured unitary member means is U-shaped. An additional unitary member means embodiment is substantially concentric with interconnected wheel assemblies 120, 120′. Other embodiments are within the scope of the present subject matter.

The wheel assemblies of the axle 118 include a first extension 404 and a second extension 404′ contralateral the first extension. The first and second extensions displace the wheels from the unitary member 110 a distance D₁. In various embodiments, displacement D₁ is useful to facilitate elevation adjustment of a trailer. For example, displacement D₁ enables the trailer to rest over the unitary member while the base portion of the shelter is lowered onto a planar surface.

FIG. 4 is a break-away side view of a recess, according to one embodiment of the present subject matter. In various embodiments, the recess 114 benefits form the support of an attached reinforcement plate 502. Other variations of the recess 114 are within the scope of the present subject matter.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

We claim:

1. A trailer, comprising:
an ice fishing shelter including a base with a recess;
a first pivot arm and a second pivot arm interconnected by a unitary member, the first pivot arm connected to the ice fishing shelter at a first joint and the second pivot arm connected to the ice fishing shelter at a second joint;
a first wheel assembly connected to the first pivot arm; and
a second wheel assembly connected to the second pivot arm;
wherein the adjustable actuator is adapted to position the first pivot arm and the second pivot arm with respect to the ice fishing shelter to elevate the ice fishing shelter and base for towing on the first wheel assembly and the second wheel assembly and to lower the ice fishing shelter and base to a planar surface with the recess accommodating the unitary member.

2. The trailer of claim 1, wherein the first wheel assembly includes a first leaf spring shackled to the first pivot arm, and the second wheel assembly includes a second leaf spring shackled to the second pivot arm.

3. The trailer of claim 1, wherein the unitary member is tube shaped.

4. The trailer of claim 1, wherein the first pivot arm is lockable to the ice fishing shelter, and the second pivot arm is lockable to the ice fishing shelter.

5. The trailer of claim 4, further comprising a plurality of pins adapted to lock the first pivot arm and the second pivot arm to the ice fishing shelter.

6. The trailer of claim 1, further comprising a pivoting hitch tongue connected to the ice fishing shelter.

7. The trailer of claim 6, wherein the adjustable actuator is connected to the pivoting hitch tongue.

8. The trailer of claim 6, wherein the pivoting hitch tongue is adapted for connection to a vehicle hitch during elevation adjustment of the ice fishing shelter.

9. The trailer of claim 6, wherein the pivoting hitch tongue is lockable to the ice fishing shelter.

10. The trailer of claim 1, wherein the adjustable actuator is a hand adjustable winch.

11. The trailer of claim 10, wherein the adjustable actuator is mechanically connected between the first pivot arm and the ice fishing shelter with a first cable set, and further mechanically connected between the second pivot arm and the ice fishing shelter with a second cable set.

12. The trailer of claim 10, further comprising a plurality of pulleys threaded with cabling, the cabling extending from the hand adjustable winch to the first and second pivot arms.

13. The trailer of claim 1, wherein a center line of the unitary member is offset from a centerline extending between the center of the first wheel assembly and the second wheel assembly.

14. The trailer of claim 13, wherein a pivot axis extends between a first joint around which the first pivot arm is adapted to rotate and a second joint around which the second pivot arm is adapted to rotate, and the center line of the unitary member is offset toward the pivot axis a distance measured in a plane parallel the ground surface.

15. A trailer, comprising:
an ice fishing shelter, including a base;
a first pivot arm connected to the ice fishing shelter, the first pivot arm connected to a first wheel assembly means for rolling the trailer across a planar surface;
a second pivot arm connected to the ice fishing shelter, the second pivot arm connected to a second wheel assembly means for rolling the second pivot arm across the planar surface;
a unitary member means for interconnecting the first wheel assembly means and the second wheel assembly means; and
elevation means for adjusting the elevation of the ice fishing shelter and the base,
wherein the elevation means are adapted to elevate the ice fishing shelter means and base for towing on the first wheel assembly means and the second wheel assembly means and to lower the ice fishing shelter means and base to the planar surface with the unitary member means disposed between the base and the planar surface.

16. The trailer of claim 15, further comprising a pivoting hitch means connected to the ice fishing shelter means at a tongue joint and adapted for connection to a vehicle hitch during adjustment of the elevation of the ice fishing shelter means.

17. The trailer of claim 15, wherein the ice fishing shelter means has a floor containing at least one aperture sized for ice fishing.

18. The trailer of claim 15, wherein the actuator means include a hand adjustable winch.

19. A trailer, comprising:
an ice fishing shelter including a base with a recess;
a first pivot arm connected to the ice fishing shelter at a first joint;
a the second pivot arm connected to the ice fishing shelter at a second joint;
a first wheel connected to a first hub, the first hub connected to a first leaf spring, the first leaf spring connected to the first pivot arm;
a second wheel connected to a second hub, the second hub connected to a second leaf spring, the second leaf spring connected to the second pivot arm;
a unitary member interconnecting the first hub and the second hub;
a pivoting hitch tongue connected to the ice fishing shelter at a third joint; and
a hand adjustable winch connected to the pivoting hitch tongue with cabling extending between the hand adjustable winch and the first and second pivot arm, the cabling controlling the position of the first and second pivot arm with respect to the ice fishing shelter,
wherein the hand adjustable winch is adapted to elevate the ice fishing shelter and base for towing on the first wheel and the second wheel and to lower the ice fishing shelter and base to a planar surface with the recess accommodating the unitary member.

20. The trailer of claim 19, further comprising a plurality of pulleys threaded with cabling, the cabling extending from the hand adjustable winch to the first and second pivot arms.
